(19) United States
(12) Patent Application Publication
(10) Pub. No.: US 2012/0149233 A1
(43) Pub. Date: Jun. 14, 2012

(54) TERMINAL STRUCTURE AND ELECTRICAL CONNECTOR USING THE SAME

(76) Inventor: Chih-Yu HSUEH, Taipei City (TW)

(21) Appl. No.: 13/325,350

(22) Filed: Dec. 14, 2011

(30) Foreign Application Priority Data
Dec. 14, 2010 (TW) 099224253

(51) Int. Cl. H01R 4/24

(52) U.S. Cl. 439/395

(57) ABSTRACT

A terminal structure having a first insulation displacement contact and a first holding portion. The first insulation displacement contact has a pair of first insulation displacement blades and a first insulation displacement slot located between the first insulation displacement blades. One end of the first holding portion is connected to one end of the first insulation displacement contact. The pair of the first insulation displacement blades are bent in a direction away from the first holding portion. Another end of the first holding portion is bent in a direction away from an opening of the first insulation displacement slot and extends to form a spring arm, wherein a gap is formed between the spring arm and the first insulation displacement slot, and the extending direction of the spring arm is perpendicular to the extending direction of the first holding portion.

### BACKGROUND OF THE INVENTION

1. Field of the Invention

The present invention relates to a terminal structure with an insulation displacement contact (IDC) and more specifically to an electrical connector having the terminal structure.

2. Description of the Prior Art

The insulation displacement connection (IDC) technology does not require the process of excoriating wire or soldering. In this way, the wire and the terminal structure can be connected together quickly and therefore the IDC technology is used extensively in the cable connector field. The conventional insulation displacement connection technique presses the wire onto a slit of a flat wall disposed on the terminal structure, wherein edges of the slit will puncture the insulation covering of the wire and then are electrically connected to the core of the wire. The slit is formed by two opposite edges of a metal sheet, wherein the thickness of the metal sheet is able to ensure that the strength of the edges can withstand the applied contact pressure.

The size of the power wire used to transmit power signals is usually greater than the size of wires for other uses and the power wire has relatively thicker insulation covering. If one of the power wires is not punctured or improperly punctured, the power core of the wire and the corresponding terminal cannot form a proper electrical connection which may bring adverse effects to the transmission of power between the power wire and the terminals.

U.S. Pat. No. 4,410,222, U.S. Pat. No. 5,030,132, and U.S. Pat. No. 6,524,127 disclose several types of insulation displacement connection terminal structures respectively. Those terminal structures disclosed have two slits to increase the contact area between the wire and the insulation displacement contact of the terminal in order to ensure the reliability of transmitting data signals and power between the terminals and the wire. The U.S. Pat. No. 4,410,222 discloses a first insulation body accommodating the insulation displacement connection terminal structure, a second insulation body aligning the terminal with the wire, and a casing disposed outside the first insulation body and the second insulation body to ensure the reliable connection between the terminals and the wire. The insulation displacement connection contacts of the insulation displacement connection terminal structure disclosed in U.S. Pat. No. 4,410,222 are completely exposed outside the insulation bodies. The insulation displacement connection contacts have no supporting structure and therefore when a flat wire is pressed into the slit of the terminal structure, the insulation displacement connection contact may be deformed and render the signal transmission between the wire and the terminals unreliable. Furthermore, the structure of the casing is suitable for flat cables and not for a single wire.

U.S. Pat. No. 5,030,132 and U.S. Pat. No. 6,524,127 disclose insulation displacement connection contacts of a terminal structure supported by an inner wall formed by an accommodation cavity passing through the insulation body. However, when the operator presses the wire into the slit of the terminal structure, a portion of the above-mentioned inner wall may block the view of the operator and therefore the assembly accuracy cannot be guaranteed. Furthermore, when the wire is accommodated in the slit of the terminal structure, an extra protection structure is needed to prevent the wire from coming off the slit. More specifically, the terminal structure disclosed by U.S. Pat. No. 5,030,132 includes a claw structure to prevent the wire from coming off the terminal structure. However, the above-mentioned structure may complicate the terminal structure which increases the costs of production and difficulty of manufacture.

The terminal structure disclosed in the above-mentioned published documents still cannot satisfy the market demand for versatile electrical connectors that can be used in various technology fields. The inventor wishes to improve the defects mentioned above and the present invention is the solution for the long-existing problems of manufacturing electrical connectors of certain specifications and the associated costs.

### SUMMARY OF THE INVENTION

It is an objective of the present invention to provide an electrical connector that punctures and fastens the wire by a terminal to form electrical connection.

It is another objective of the present invention to provide a solderless terminal and an electrical connector using the same.

It is yet another objective of a labor-saving and a cost-effective terminal structure and an electrical connector using the same.

It is yet another objective of the present invention to provide a terminal structure used in a SATA (Serial Advanced Technology Attachment) connector.

The present invention provides a terminal structure having a first insulation displacement contact and a first holding portion. The first insulation displacement contact has a pair of first insulation displacement blades and a first insulation displacement slot located between the first insulation displacement blades. One end of the first holding portion is connected to one end of the first insulation displacement contact. The pair of the first insulation displacement blades is bent in a direction away from the first holding portion. Another end of the first holding portion is bent in a direction away from an opening of the first insulation displacement slot and extends to form a spring arm, wherein a gap is formed between the first insulation displacement contact and the spring arm, and the extending direction of the spring arm is perpendicular to an extending direction of the first holding portion.

In a preferred embodiment, the terminal structure further includes an extension arm and a fastening portion. The extension arm is bent and extends from the first holding portion in a direction away from the opening of the first insulation displacement slot, wherein the extension arm is connected to the first holding portion and the spring arm. The extension arm perpendicularly connects the first holding portion and the spring arm. The fastening portion extends from the extension arm and is opposite to the spring arm, wherein the extending direction of the fastening portion is perpendicular to the extending direction of the first holding portion.

The present invention provides an electrical connector including the above-mentioned terminal structure and an insulation body. The insulation body has a plurality of slots for accommodating the terminal structure, wherein the spring arm enters the insulation body when the terminal structure is inserted in the slot.

### BRIEF DESCRIPTION OF THE DRAWINGS

FIG. 1A illustrated the first embodiment of the terminal structure of the present invention;

FIG. 1B is another schematic view of the terminal structure illustrated in FIG. 1;

FIG. 2A is a front view of the terminal structure of the present invention and a wire assembled together;

FIG. 2B is a side view of the terminal structure of the present invention and the wire assembled together;

FIG. 3A illustrates the terminal structure in the second embodiment of the present invention;

FIG. 3B illustrates the terminal structure in the third embodiment of the present invention;

FIG. 3C illustrates the terminal structure in the fourth embodiment of the present invention;

FIG. 4A is another schematic view of the terminal structure in the third embodiment of the present invention;

FIG. 4B is another schematic view of the terminal structure in the fourth embodiment of the present invention;

FIG. 5 is an exploded view illustrating an electrical connector using the terminal structure of the present invention;

FIG. 6 is an assembly view of the electrical connector illustrated in FIG. 5;

FIG. 7A is a top view of the electrical connector of the present invention;

FIG. 7B is a cross-sectional view of the electrical connector along the line A-A illustrated in FIG. 7A; and

FIG. 7C is a cross-sectional view of the electrical connector along the line B-B illustrated in FIG. 7A.

### DETAILED DESCRIPTION OF THE PREFERRED EMBODIMENT

The present invention provides a terminal structure that can directly puncture and fasten the wire to provide signal or current transmission as well as an electrical connector using the same. In a preferred embodiment, the above mentioned electrical connector is a SATA electrical connector. However, in different embodiments, the electrical connector includes but is not limited to crimp connectors, header connectors or other electrical connectors that can utilize such a puncturing type terminal structure. In addition, the wire to be connected with the electrical connector is preferably an electronic cable. However, in different embodiments, the above-mentioned wire includes a twist-pair wire or other similar wires.

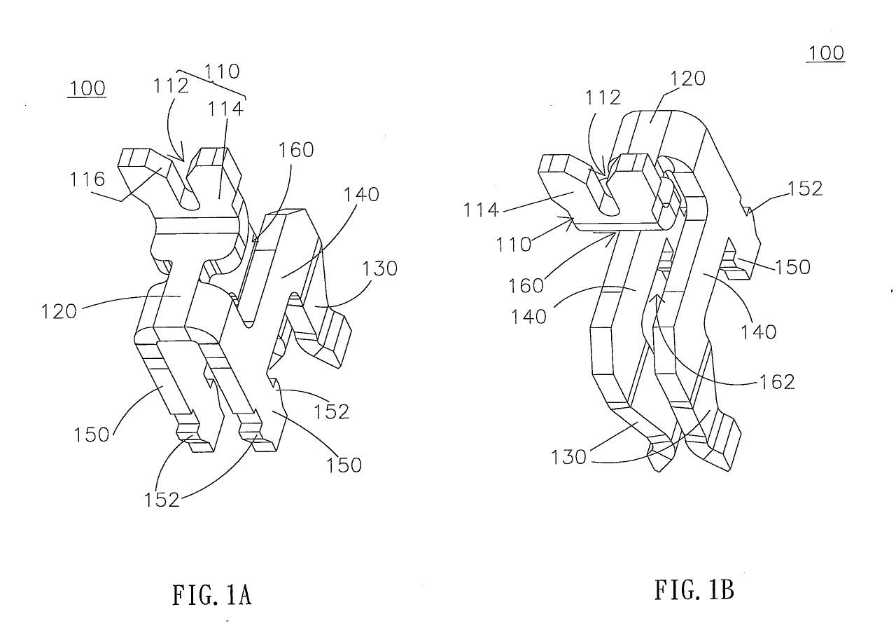

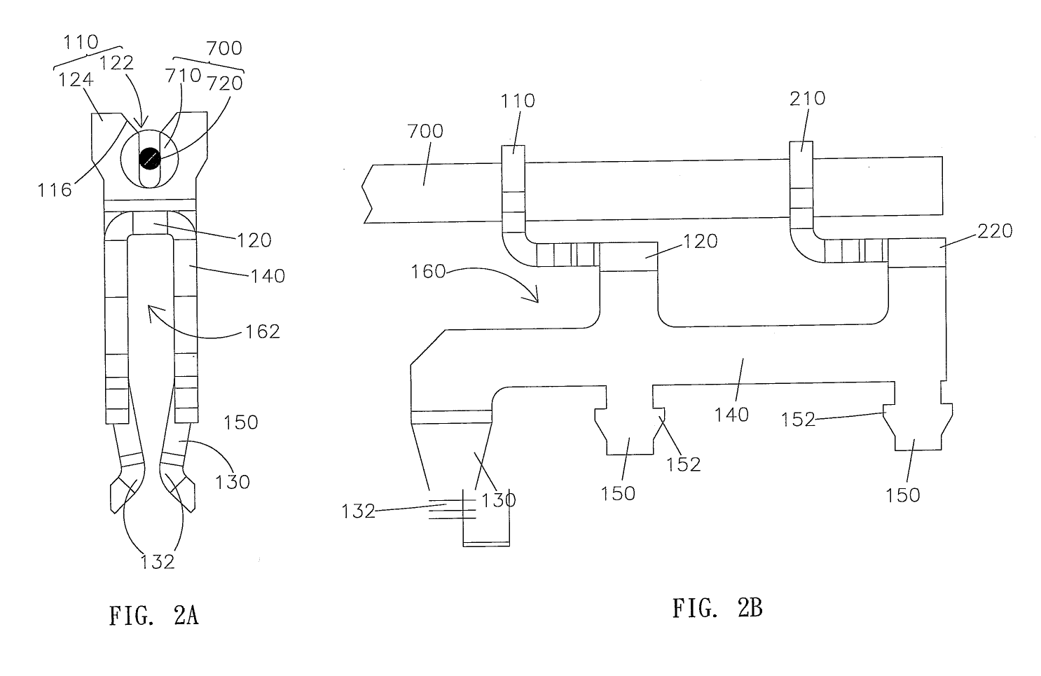

As FIG. 1A and FIG. 1B show, the present invention is a terminal structure 100 having a first insulation displacement contact 110 and a first holding portion 120. The first insulation displacement contact 110 has a pair of first insulation displacement blades 114 and a first insulation displacement slot 112 located between the first insulation displacement blades 114. As shown in FIGS. 1A-2B, the first insulation displacement slot 112 is used for puncturing a wire 700. The width of the opening of the first insulation displacement slot 112 is smaller than the width of the bottom of the slot 112. However, in different embodiments, the width of the opening of the first insulation displacement slot 112 can be equal to the width of the bottom of the slot 112. The shape of the bottom of the first insulation displacement slot 112 can be circular, triangular, irregular, or a combination thereof. The above-mentioned wire 700 includes but is not limited to an electronic wire, a mini coaxial cable, a twist-pair wire, or other similar wires. As shown in FIG. 2A, the wire 700 includes a core 720 and an insulation material 710 covering the core 720. The core 720 of the present embodiment is preferably a single core 720 made of conductive materials such as copper, silver, aluminum, or any alloy thereof. However, in different embodiments, the core 720 can be made a plurality of wires wound together in a bundle. Furthermore, the opening of the first insulation displacement slot 112 further includes a guiding portion 116 for fastening and pressing the wire 700.

In the embodiment illustrated in FIG. 1A and FIG. 1B, one end of the first holding portion 120 is connected to one end of the first insulation displacement contact 110, wherein the first insulation displacement contacts 110 are bent vertically in a direction away from the first holding portion 120 by an angle of about 90°. The pair of first insulation displacement blades 114 is formed on the first insulation displacement contact 110. The depth/length and width of the first insulation displacement slot 112 can vary depending on the size of the corresponding wire 700. However, the width of the first insulation displacement slot 112 is smaller than the outer diameter of the core 720 in order to clamp and fasten the core 720 in the slot 112 as illustrated in FIG. 2A. As shown in FIG. 2B, the wire 700 is preferably clamped in the first insulation displacement slots (not illustrated) by two or more first insulation displacement contacts 110, 210 to be firmly fastened on the terminal structure 100. However, as FIG. 1A and FIG. 1B show, the wire 700 can be clamped and fastened by only one first insulation displacement contact 110.

As shown in FIG. 1A and FIG. 1B, another end of the first holding portion 120 is bent in a direction away from the opening of the first insulation displacement slot 112 and extends to form a spring arm 130, wherein a gap 160 is formed between the first insulation displacement contact 110 and the spring arm 130. The first holding portion 120 is bent substantially vertically downward to form an extension arm 140, wherein the spring arm 130 is formed from the extension arm 140. In the present embodiment, the terminal structure 100 further includes a first fastening portion 150 having an interfering portion 152. The first fastening portion 150 is formed at one end of the extension arm 140 and disposed corresponding to the spring arm 130. The extending direction of the first fastening portion 150 is perpendicular to the extending direction of the first holding portion 120, wherein the length of the first fastening portion 150 is normally shorter than the length of the spring arm 130. The number of the fastening portions 150 to be formed can be adjusted based on the size of the terminal structure 100. In other words, the larger the terminal structure 100 is the number of the fastening portions 150 increases. For instance, the embodiment illustrated in FIG. 2B includes two fastening portions 150. The interfering portion 152 with the shape of a wedge can facilitate fastening of the terminal structure 100 on the insulation body (not illustrated).

More specifically, in the embodiment illustrated in FIG. 1A and FIG. 1B, the spring arm 130, the extension arm 140, and the first fastening portion 150 are disposed in a pair. In other words, the spring arm 130, the extension arm 140, and the first fastening portion 150 are formed by bending two ends of the first holding portion 120 in order to be firmly fastened on the electrical connector (not illustrated). A gap 162 is formed between the pair of spring arms 130, the pair of extension arms 140, and the pair of first fastening portions 150. The size of the gaps 160, 162 can be adjusted based on the size of the electrical connector, the plug space, and/or other requirements.

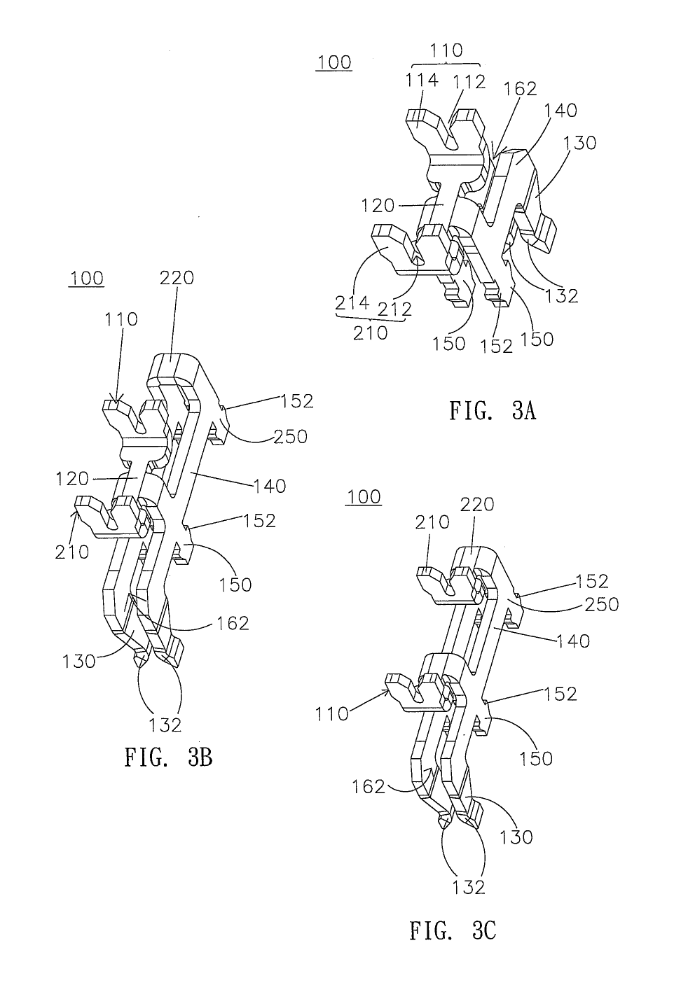

FIG. 3A is the second embodiment of the terminal structure of the present invention. In the present embodiment, the terminal structure 100 further includes a second insulation displacement contact 210 opposite to the first insulation displacement contact 110. The second insulation displacement contact 210 is formed by bending the other end of the first holding portion 120 opposite to the first insulation displacement contact 110. The second insulation displacement contact 210 has a second insulation displacement slot 212 and a second insulation displacement blade 214 opposite to the first insulation displacement slot 112 and the first insulation displacement blade 114 respectively, i.e. the first insulation displacement contact 110 and the second insulation displacement contact 210 have similar heights. Other portions of the terminal structure 100 of the present invention can refer to those illustrated in FIG. 1A and FIG. 1B and will not be elaborated here.

As FIG. 3B shows, the terminal structure 100 further includes a second holding portion 220 and a second fastening portion 250. In the present embodiment, the second holding portion 220 is connected to the extension arm 140, wherein the second fastening portion 250 extends from the extension arm 140. The height of the second fastening portion 250 is preferably equal to the height of the first fastening portion 150 and lower than the height of the spring arm 130. However, in different embodiments, the first fastening portion 150 and the second fastening portion 250 can have different heights. FIG. 3C illustrates another variation of the terminal structure 100 illustrated in FIG. 3A. In the present embodiment, the second insulation displacement contact 210 is formed on the second holding portion 220. The first insulation displacement contact 110 and the second insulation displacement contact 210 are preferably bent toward the spring arm 130 in order to maintain the center of mass at the center of the terminal structure 100. In the embodiments illustrated in FIG. 3B and FIG. 3C, the additional second holding portion 220 and the second fastening portion 250 can improve the strength and reliability as the terminal structure 100 is plugged on an electrical connector (not illustrated) if adequate plug space is available.

Furthermore, in the embodiments illustrated in FIGS. 3A-3C, the spring arm 130 further includes a contact portion 132 bent slightly toward the gap 162. The contact portion 132 is configured to electrically connect the corresponding electrical connector.

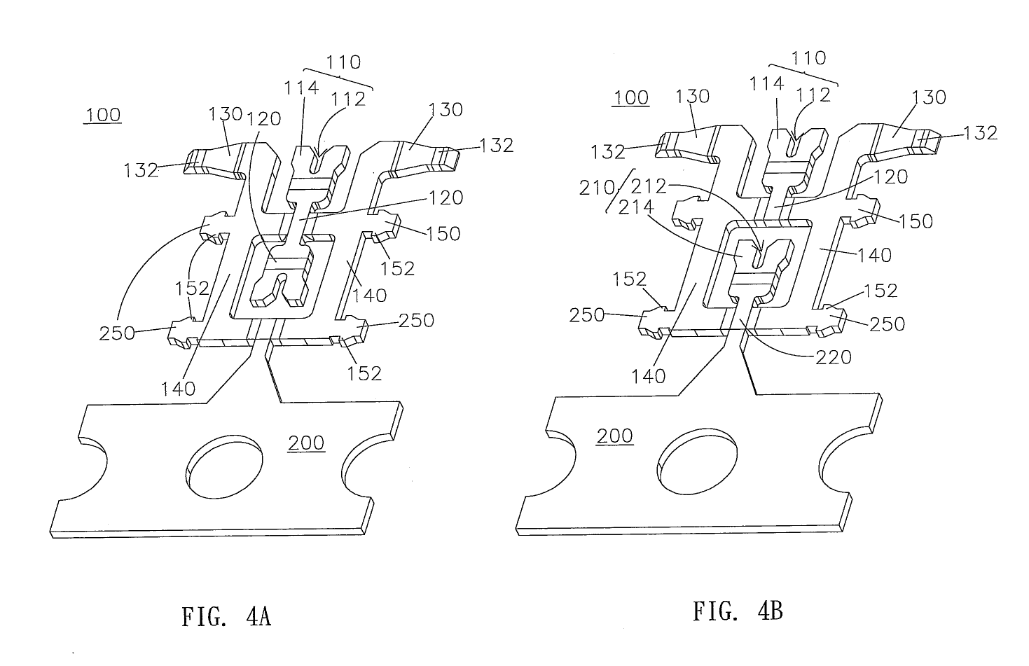

Hereinafter, how the terminal structure 100 is formed will be further explained in detail with reference to FIG. 4A and FIG. 4B. FIG. 4A is a planar view of the terminal structure 100 illustrated in FIG. 3B; FIG. 4B is a planer view of the terminal structure 100 illustrated in FIG. 3C. On the other hand, the method of forming the terminal structure in other embodiments will not be elaborated here. As shown in FIG. 4A and FIG. 4B, the terminal structure 100 is preferably formed by stamping, forging, or other similar methods and connected to a tape 200. In other words, the portions of the terminal structure 100 including the first insulation displacement contact 110, the second insulation displacement contact 210, the first holding portion 120, the second holding portion 220, the spring arm 130, the first fastening portion 150, and the second fastening portion 250 are preferably formed in an integral form by stamping one or more times. The terminal structure 100 is preferably made of copper, silver, and an alloy thereof or formed by plating copper, gold, or silver on a base material such as steel or iron.

The method of forming the terminal structure 100 preferably includes first bending the contact portion 132 of the spring arm 130 and then bending the holding portions 120, 220 so that the spring arm 130, the extension arm 140, and the fastening portions 150, 250 are perpendicular to the holding portions 120, 220. Finally, the first insulation displacement contact 110 and the second insulation contact 210 are bent vertically to the holding portions 120, 220. However, in different embodiments, the method can include bending the insulation displacement contacts 110, 210 to be perpendicular to the holding portions 120, 220 and then bending the contact portion 132 of the spring arm 130, the extension arm 140, the spring arm 130, and the fastening portions 150, 250 to be perpendicular to the holding portions 120, 220. It should be noted here that the bending order of the terminal structure 100 can be adjusted based on designs and manufacture processes and is not limited to those described above.

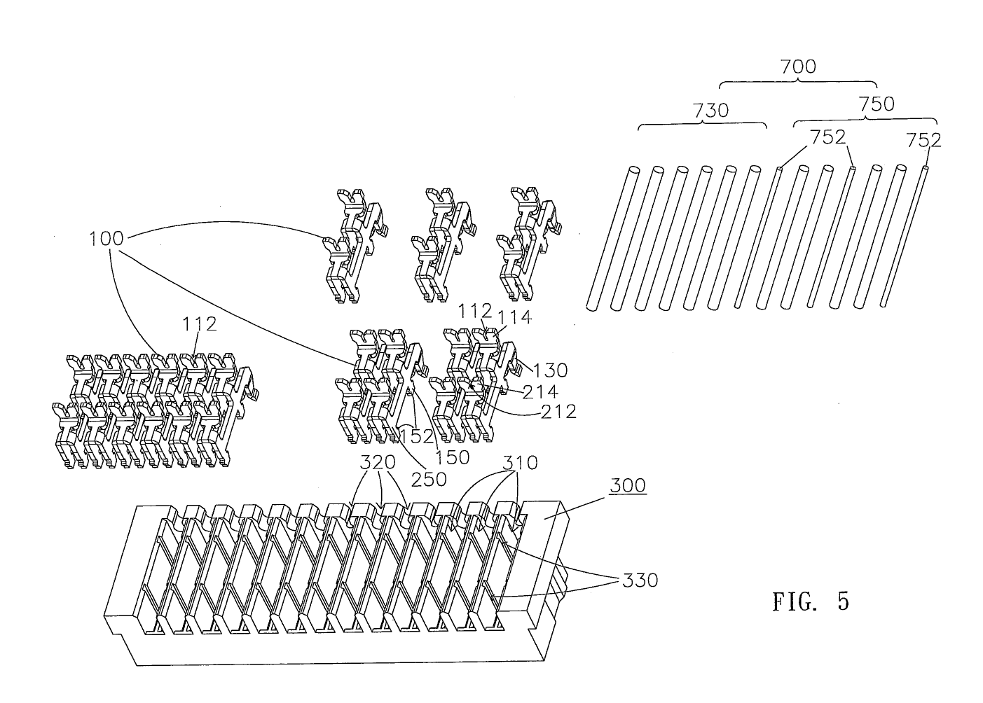

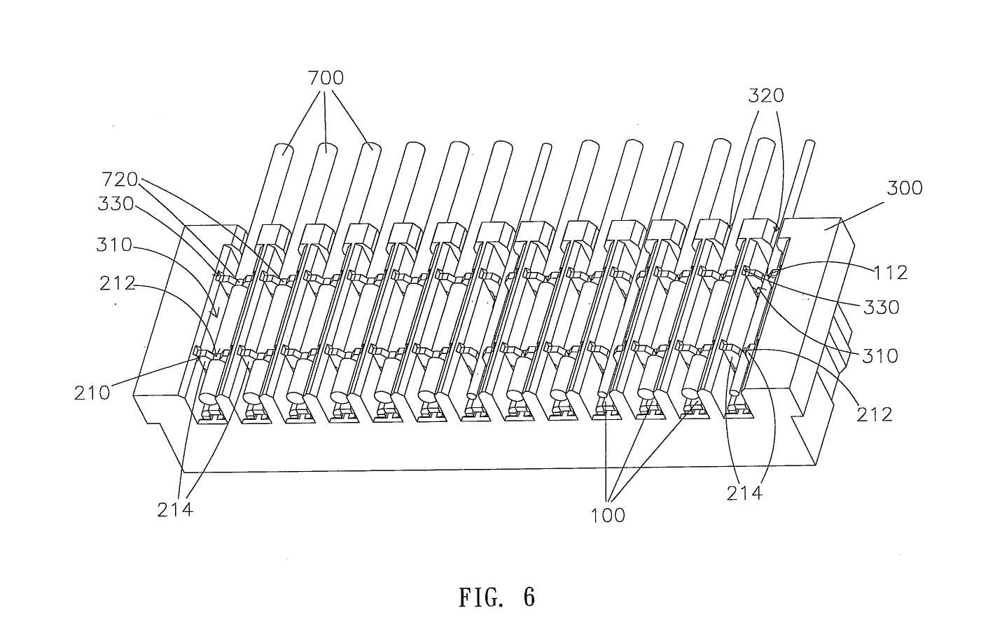

As FIG. 5 and FIG. 6 show, the present invention provides an electrical connector including the above-mentioned terminal structure 100 and the insulation body 300. In the present embodiment, the size of the terminal structure 100 is determined based on the size and the plug space of the insulation body 300 or other factors. Therefore, the terminal structure 100 of the present embodiment illustrated in FIG. 5 and FIG. 6 is an exemplary embodiment. The electrical connector described here preferably includes SATA connectors but is not limited thereto. As FIG. 5 and FIG. 6 show, the wire 700 of the electrical connector of the present embodiment includes a power cord 730 and a signal line 750, wherein the signal line 750 further includes ground line 752. The number of wires 700 and the type or size of the wires 700 can be changed based on the type of the corresponding electrical connector.

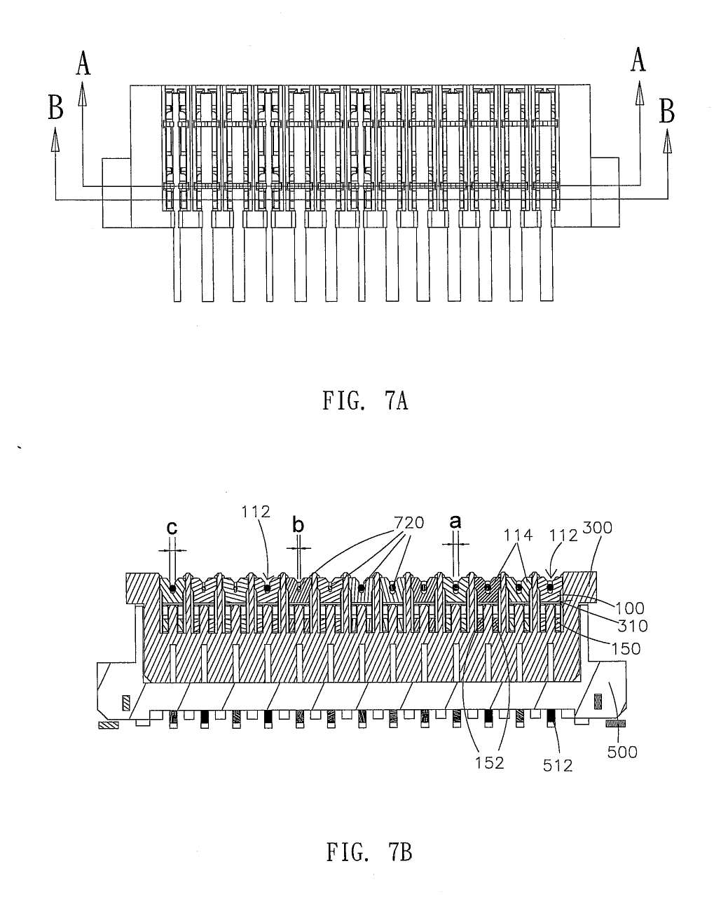

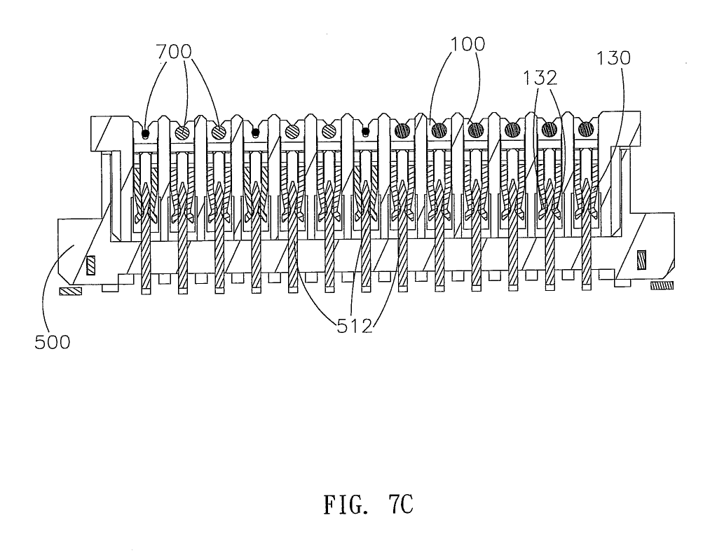

In the embodiment illustrated in FIG. 5, the width of the opening of the first insulation displacement slot 112 can be modified based on the diameter of the core 720. In other words, the diameter of the ground line 752 is normally smaller than the diameter of the power core 730 and the diameter of the signal line 750. Therefore, the width of the insulation displacement slots 112, 212 for the ground line 752 of the terminal structure 100 is smaller than the width of the insulation displacement slots 112, 212 for other wires. More precisely, the width of the opening of the insulation displacement slots 112, 212 and the shape of the bottom of the insulation displacement slots 112, 212 are preferably designed based on the size of the core 720 of the wire 700 in order to puncture and fasten the core 720, as illustrated in FIG. 7B. Furthermore, a guiding slot 330 is formed at the side wall of the slot 310 of the electrical connector 300 in order to fasten the insulation displacement contacts 110, 210 and limit their displacement perpendicular to the slot 310 of the insulation body 300. The number of guiding slots 330 and their locations can be modified based on the number and the location of the corresponding the insulation displacement contacts 110, 210.

As shown in FIG. 5, when the terminal structure 100 is fitted into the corresponding slot 310, the fastening portions 150, 250 are plugged in the plastic portion on the bottom of the slot 300 of the insulation body 300, as illustrated in FIG. 7B. Furthermore, the insulation displacement contacts 110, 210 are fixed in the slot 310 along two corresponding guiding slots 330. As shown in FIG. 5 and FIG. 6, when the wire 700 is fitted into the insulation displacement slots 112, 212, the wire 700 will be confined in the terminal slot 320 of the insulation body 300 to improve the fastening strength of the wire 700. The size of the terminal slot 320 is preferably similar to the diameter of the wire 700. As such, when the core 720 of the wire 700 is fitted into the insulation displacement slot 112, 212 of the terminal structure, the assembly process is completed, i.e. the signal/current coupling process is complete. The process of using the terminal structure 100 to puncture and fasten the wire 700 is both cost-effective and labor-saving, and therefore is more competitive on the market.

FIGS. 7A-7C illustrate the embodiment where the electrical connector of the present invention is coupled with the corresponding connector. FIG. 7B and FIG. 7C are cross-sectional views along the lines A-A and B-B illustrated in FIG. 7A. In the embodiment illustrated in FIG. 7B, the core 720 of the wire 700 is preferably fitted near the bottom of the first insulation displacement slot 112. However, in different embodiments, each of the cores 720 can be completely embedded at the bottom of the first insulation displacement slot 112. As shown in FIG. 7B and FIG. 7C, the cores 720 have different diameters a, b, and c whereas the insulation displacement slots 112, 212 have different widths and bottom shapes corresponding to different diameters a, b, and c. However, the width of the insulation displacement slot 112, 212 is smaller than the corresponding diameter a, b, or c.

In the embodiment illustrated in FIG. 7C, the spring arm 130 of the terminal structure 100 extends into the insulation body 300 to electrically connect the terminals 512 of the corresponding connector 500. In other words, each pair of the terminals 512 is clamped by the contact portions 132 of one pair of the spring arm 130 to form electrical connection.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A terminal structure, comprising:
a first insulation displacement contact, having a pair of first insulation displacement blades and a first insulation displacement slot located between the first insulation displacement blades; and
a first holding portion, with one end connected to one end of the first insulation displacement contact, the pair of the first insulation displacement blades bending in a direction away from the first holding portion, another end of the first holding portion bending in a direction away from an opening of the first insulation displacement slot and extending to form a spring arm, wherein an extending direction of the spring arm is perpendicular to an extending direction of the first holding portion.

2. The terminal structure of claim 1, further including an extension arm extending from the first holding portion and connecting the first holding portion and the spring arm.

3. The terminal structure of claim 2, wherein the extension arm perpendicularly connects the first holding portion and the spring arm.

4. The terminal structure of claim 2, further including a fastening portion extending from the extension arm and opposite to the spring arm, wherein an extending direction of the fastening portion is perpendicular to the extending direction of the first holding portion.

5. The terminal structure of claim 4, further including a second insulation displacement contact connected to the extension arm by a second holding portion, wherein the second insulation displacement contact is bent corresponding to the first insulation displacement contact and is located between the first holding portion and the second holding portion.

6. The terminal structure of claim 1, wherein an opening of the first insulation displacement slot further includes a guiding portion.

7. The terminal structure of claim 1, further including a second insulation displacement contact bent and extending from the first holding portion opposite to the first insulation displacement contact, wherein the second insulation displacement contact has a pair of second insulation displacement blades and a second insulation displacement slot, and the pair of the second insulation displacement blades are disposed corresponding to the pair of the first insulation displacement blades.

8. The terminal structure of claim 1, wherein a width of an opening of the first insulation displacement slot is smaller or equal to a width of the bottom of the first insulation displacement slot.

9. The terminal structure of claim 1, wherein the first insulation displacement contact, the first holding portion, and the spring arm are integrally formed in a single piece.

10. An electrical connector, comprising:
a terminal structure of claim 1; and an insulation body, having a plurality of slots for accommodating the terminal structure, wherein the spring arm enters the insulation body when the terminal structure is inserted into the slot.
